(19) United States
(12) Patent Application Publication
(10) Pub. No.: US 2002/0111829 A1
(43) Pub. Date: Aug. 15, 2002

(54) Method and associated apparatus for electronic prescription handling

(76) Inventor: Kenneth Robibero, Hawthorne, NJ (US)

Correspondence Address: R. Neil Sudo, COLEMAN SUDOL SAPONE, P.C., Fourteenth Floor, 708 Third Avenue, New York, NY, 10017-4101, US

(21) Appl. No.: 09/780,221

(22) Filed: Feb. 9, 2001

(51) Int. Cl. G06F 17/60

(52) U.S. Cl. 705/3

(57) ABSTRACT

A data handling and transfer system includes an interface for receiving or retrieving blocks of data from different applications programs including electronic prescription generating software, the blocks of data being encoded in accordance with respective formatting conventions. The system also has a first code translator and a second code translator, the first code translator being operatively tied to the interface for converting each incoming data block from the respective formatting convention to a predetermined common formatting convention. This first code translator includes (a) a data field detector for identifying types of data elements in the incoming data blocks and (b) a definition attach module operatively connected to the data field detector for associating data definitions with respective data elements. The second code translator is operatively connected to the first code translator for converting each data block from the common formatting convention into a target software formatting convention for use by one of the applications programs. A prescription analyzer is connected between the first code translator and the second code translator for checking an incoming medical prescription for potential drug interaction.

### BACKGROUND OF THE INVENTION

The present invention relates to a data conversion apparatus and an associated data conversion methodology for converting and transferring data created by an electronic prescription system. More particularly, but not exclusively, this invention relates to a data conversion and processing system and associated methodology useful in handling electronic medical prescriptions.

Personal computers, laptops, handhelds, PocketPCs, Terminals, etc., are able to create and store medical, patient, and prescription data using a variety of information processing software. Different applications programs are commonly written in different programming languages each characterized by respective formatting conventions. Ordinarily, such programs are unable to communicate with each other. Data created in one application cannot be automatically transferred into another application, whether the applications are located on the same or different computers. Information may be transferred through manual or operator effort. With substantial applications, however, the amounts of data transfer can be so large as to be impractical or, at best, tedious and time consuming.

Programs have been devised for enabling automatic data transfer. Such data transfer programs typically require customized modification of the participating applications programs. In addition, these data transfer programs are adapted to only two programs. With more than two participating applications programs, the modifications required for data transfer can become inordinately complex and exorbitantly expensive.

### OBJECTS OF THE INVENTION

It is an object of the present invention to provide a method and/or an associated system or apparatus for facilitating data transfer among a plurality of applications programs, particularly including medical applications programs.

Another object of the present invention is to provide such a method and/or system or apparatus which may be used in conjunction with a single, stand alone computer or multiple computers connected to one another via a local area network, a global computer network, or other computer network.

A further object of the present invention is to provide a data conversion system or apparatus and/or a data conversion method.

It is a more specific object of the present invention to provide such a data conversion system and/or method which is particularly useful in the transfer and processing of electronic medical prescriptions.

These and other objects of the present invention will be apparent from the drawings and descriptions herein. It is to be noted that various embodiments of the invention may meet one or more of the objects of the invention. It is not considered necessary for any embodiment to meet all of the objects of the invention.

### SUMMARY OF THE INVENTION

The present invention is directed in part to a data conversion apparatus for converting original data created by different electronic prescription systems into data utilizable by different applications programs, possibly on different computer systems interconnected via a network, the different applications programs being written with respective formatting conventions (and possibly in completely different languages). The apparatus includes data block conversion circuitry, such as digital processing circuits modified by programming, for converting data from an electronic prescription system into a single universal or common format. A memory stores the data which has been converted into the common data format, as well as the corresponding original data. The memory may be solid-state, optical, disk, tape or similar media.

Where the applications programs are located on different computers, it is contemplated that the data conversion circuitry is located solely on a central server computer. However, in an alternative embodiment, the data conversion circuitry is duplicated and located on multiple applications computers. It that case, a data conversion system in accordance with the invention comprises a network of a plurality of interconnected computers each having conversion means or data conversion applications for converting original data created by different information processing applications into data of a predetermined common data format, as well as memories for storing the data of the common data format and the corresponding original data.

The present invention is concomitantly directed to a method for converting original output data of different electronic prescription systems into data a predetermined common data format for eventual transmission to secondary or receiver applications programs. Generally, the data is transformed from the common data format to specific dedicated formats utilizable by the respective secondary or receiver applications programs.

A data handling and transfer system comprises, in accordance with one embodiment of the present invention, an interface for receiving or retrieving blocks of data from different applications programs including electronic prescription generating software, the blocks of data being encoded in accordance with respective formatting conventions. The system additionally comprises a first code translator operatively tied to the interface for converting each incoming data block from the respective formatting convention to a predetermined common formatting convention. This first code translator includes (a) a data field detector for identifying types of data elements in the incoming data blocks and (b) a definition attach module operatively connected to the data field detector for associating data definitions with respective data elements. The system also comprises a second code translator operatively connected to the first code translator for converting each data block from the common formatting convention into a target software formatting convention for use by one of the applications programs.

The applications programs are taken from the group consisting of accounting programs, patient record keeping programs, medical record keeping programs, insurer programs, prescription generating programs, prescription fulfillment programs, claims processing programs, drug formulary programs, and drug interaction systems.

The applications programs may all be located on a single computer. In that case, the interface is operatively connected to the different applications programs for mediating communications or acting as a data clearing house or universal translator. Alternatively, the applications programs may be located on different computers. In that case, the interface is connected to the different computers via a local area network, a global computer network (the Internet), an Intranet, or other computer network.

Where the interface is connected to a computer network, the first code translator is located on a first computer connected to the network, the one applications program being located on a second computer connected to the network. In this scenario, the second code translator may be located on the first computer or on the second computer. In addition, a data transmitter is operatively coupled to the second code translator for transmitting converted data blocks therefrom to a remote computer containing the one applications program A batch and sequence generator may be operatively connected at an input side to the second code translator and at an output side to the data transmitter.

In accordance with another feature of this one embodiment of the present invention, a data processing module may be connected between the first code translator and the second code translator for operating on data blocks in the common formatting convention. The data processing module may take the form of a prescription analyzer operatively connected to the first code translator and to at least one medical database for checking an incoming medical prescription for potential drug interaction. (The term “drug interaction” as used herein refers to possible reactions induced in a patient by a drug. A newly prescribed drug may induce a reaction owing to another drug the patient is taking, a food consumed by the patient, a pre-existing medical condition of the patient, or a physiologic or organic condition, i.e., allergy.) In many cases, the data from the medical database has to be converted from a respective formatting convention to the common data format for processing. The medical database typically includes a patient records keeping database as well as a database specifying potential drug interactions. A further database may store, for each of a multiplicity of pharmaceutical agents, patient diagnoses calling for use of the respective pharmaceutical agent, as well as recommended dosages. The dosages may vary depending on various patient parameters (obtainable from the patient records keeping database) including, for instance, patient age, weight and sex, patient medical history, other drugs being taken by the patient, and formulary compliance with regard to the patient's insurance.

In accordance with a further feature of the one embodiment of the present invention, the first code translator includes a code identification or recognition unit operatively linked to the interface for determining, for each incoming data block, the formatting convention of the incoming data block. Also, an integrity check module may be operatively linked to the interface and the first code translator for verifying integrity of incoming data blocks.

An electronic medical prescription handling system comprises, in accordance with another embodiment of the present invention, an interface for receiving or retrieving blocks of data from different applications programs including electronic prescription generating software, the blocks of data being encoded in accordance with respective formatting conventions. The system additionally comprises a code translator operatively tied to the interface for converting each incoming data block from a respective formatting convention to a predetermined common formatting convention, a prescription analyzer operatively connected to the code translator for checking an incoming medical prescription for potential drug interaction, and an alert signal generator operatively coupled to the prescription analyzer for generating an alert signal upon detection of a drug interaction possibly resulting in a person by filling and use of the medical prescription.

As indicated above, the code translator may be a first code translator, with the system further comprising a second code translator operatively connected to the first code translator for converting or transforming data blocks from the common formatting convention to another formatting convention for use by one of the applications programs. Generally, it is contemplated that the first and second code translators are located on the same computer. That one computer may be a solitary unit containing all of the applications programs, including the electronic prescription generating software. Alternatively, the one computer may be a server computer on a network where various applications programs are located on different computers. In that case, instead of having both the second code translator and the first code translator located on the server computer, multiple second code translators may be provided, each located on a respective remote computer. In any event, where multiple network-interconnected computers are concerned, the system further comprises a data transmitter is provided for transferring partially or fully converted data blocks from the central server computer to selected remote computers. Where there is a single second code translator, located on the central server computer, the transmitter is operatively coupled to that code translator for transmitting converted or transformed data blocks therefrom to remote computers containing the target or secondary applications programs. A batch and sequence generator may be operatively connected at an input side to the second code translator and at an output side to the data transmitter.

Pursuant to another aspect of the present invention, the second code translator is operatively connected to the prescription analyzer for incorporating prescription analysis into transmissions to the one applications program. The second code translator may be operatively connected to the prescription analyzer for incorporating the alert signal into a transmission to the one applications program.

As discussed above with reference to the first embodiment of the present invention, the first code translator may include (a) a code identification or recognition unit operatively linked to the interface for determining, for each incoming data block, the formatting convention of the incoming data block, (b) a data field detector for identifying types of data elements in the incoming data blocks, and (c) a definition attach module operatively connected to the data field detector for associating data definitions with respective data elements. An integrity check module may operatively linked to the interface and the code translator for verifying integrity of incoming data blocks.

A medical risk control method comprises, in accordance with the present invention, receiving electronic prescriptions encoded in accordance with a variety of different software formatting conventions, automatically converting the received electronic prescriptions from the respective formats into a common formatting convention, operating a computer to automatically analyze the converted electronic prescriptions to detect possible dangers to respective patients for whom the electronic prescriptions are generated, and transmitting the analyzed electronic prescriptions to respective target applications programs. In addition, the analyzed electronic prescriptions and results of the prescription analysis may be automatically converted or transformed into preselected software formats utilizable by the respective target applications programs. The prescription data and the results of the analysis are transmitted to the respective applications programs, which may be located on a single computer or on different computers interconnected via a network. The converting of the analyzed electronic prescriptions and the results of the prescription analysis may be performed prior to or after the transmitting of analyzed electronic prescriptions to the respective target applications programs. Where the electronic prescriptions are received over a computer network from remote computers and the target applications programs are located on remote computers, the transmitting of the analyzed electronic prescriptions include transmitting the analyzed electronic prescriptions over the computer network.

Pursuant to aspects of the present invention alluded to hereinabove, the automatic converting of the received electronic prescriptions from the respective formats into a common formatting convention includes automatically determining, for each incoming data block, the formatting convention of the incoming data block, while the automatic converting of the received electronic prescriptions from the respective formats into a common formatting convention includes identifying types of data elements in the received electronic prescriptions and attaching data definitions to respective data elements. The method may additionally comprise automatically verifying integrity of incoming data blocks.

Where the electronic prescriptions are generated for respective patients, it is contemplated that the operating of the computer to automatically analyze the received electronic prescriptions includes accessing a medical records database to determine drugs currently being taken by the respective patients, automatically accessing a drug interaction database, and automatically determining whether fulfillment and utilization of any one of the electronic prescriptions by a respective one of the patients is contraindicated by a possible deleterious drug interaction.

A data handling and transfer method comprises, in accordance with another embodiment of the present invention, (I) receiving incoming data blocks from different applications programs including electronic prescription generating software, the incoming data blocks being encoded in respective languages or in accordance with respective formatting conventions, and (ii) automatically converting each incoming data block from the respective formatting convention to a predetermined common formatting convention. The converting of each data block includes (a) identifying types of data elements in the respective data block and (b) attaching data definitions to respective data elements. The method further comprises (iii) automatically transforming each converted data block from the common formatting convention into a target formatting convention for use by at least one of the applications programs.

As discussed above, the converting and the transforming of the data blocks may occur on the same computer. In that case, all of the applications programs may also be located on that same computer. However, it is alternatively possible to have the converting (to the common data format) and the transforming (from the common data format) of the data blocks performed on one computer and to have the applications programs located on different computers connected to the one computer via a network. In the latter event, the method additionally comprises transmitting transformed data blocks to a remote computer containing the one applications program.

In an alternative procedure, the converting and the transforming of the data blocks occur on different computers connected to one another via a network. Then the method further comprises transmitting the converted data blocks from a first one of the different computers to a second one of the different computers prior to the transforming of the converted data blocks.

Pursuant to an additional aspect of this embodiment of the present invention, the method may also comprise operating on converted data blocks in the common formatting convention prior to transforming of the data blocks from the common formatting convention to the target language or formatting convention. Where the data blocks include electronic medical prescriptions, the operating on converted data blocks includes accessing at least one medical database and checking an incoming medical prescription for potential drug interaction.

In at least some of the embodiments of the present invention, where the transforming of the converted data blocks is performed (by a code translator) only at a central server computer, no conversion program need be added to the information processing software or applications programs on the remote (client) computers. Thus, commercially available electronic prescription systems may be used off-the-shelf, without modification prior to use in conjunction with other applications programs such as accounting or billing software, insurance tracking software, patients or medical records keeping programs, prescription fulfillment software, claims processing programs, drug formulary programs, and drug interaction systems.

Furthermore, since the network is constructed by connecting a plurality of computers having the conversion means, even when the electronic prescription system which creates the data to be translated is not installed in the computer having the universal connector, or even when the operating system (OS) of the computer is different from that of another computer that created data to be converted, the computer may receive data of a common data format from the other computer through the network. Therefore, it is possible to translate electronic prescription data created by any electronic prescription system of such other computer with ease.

### BRIEF DESCRIPTION OF THE DRAWINGS

FIG. 1 is a block diagram of a computer network incorporating a data conversion and transfer system and a prescription monitoring system in accordance with the present invention.

FIG. 2 is a block diagram of a prescription monitoring system and a code translator shown in FIG. 1.

FIG. 3 is a block diagram of a single computer primarily dedicated to medical use and containing a prescription monitoring system and a code translator in accordance with the present invention.

FIG. 4 is a block diagram of the prescription monitoring system and code translator of FIG. 3.

### DESCRIPTION OF THE PREFERRED EMBODIMENTS

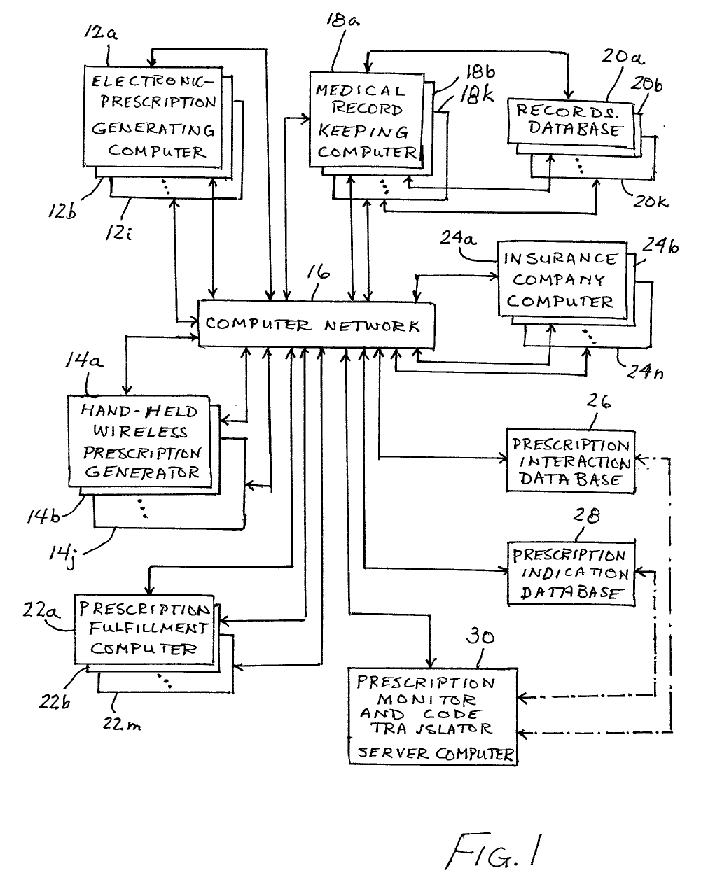

As illustrated in FIG. 1, a distributed medical data processing and communication system comprises a plurality of electronic prescription generating computers 12a, 12b, . . . 12i and hand-held wireless prescription generators 14a, 14b, . . . 14j all operatively connected to a computer network 16. Computer network 16 may take the form of a local area network, a private regional or global computer network (e.g., corporate), a public global computer network, namely, the Internet, or a closed password-protected portion of the Internet known as an Intranet, or various combinations of these networks.

Prescription generating computers 12a, 12b, . . . 12i are general-purpose digital computers (laptops, desktops, mainframes, etc.) loaded with prescription generating applications programs or accessing such programs stored on other computers or databases. Accordingly, computers 12a, 12b, . . . 12i contain generic digital processing circuits modified by the applications software to generate medical prescriptions. Typically, the electronic prescriptions are for pharmaceutical agents or therapeutic drugs. However, other forms of prescriptions may be generated, such as for exercise regimens and diets.

Also connected to computer network 16 are a plurality of medical record keeping computers 18a, 18b, . . . 18k operatively connected to respective medical records keeping databases 20a, 20b, . . . 20k. Computers 18a, 18b, . . . 18k are exemplarily located in hospitals and physicians' offices and serve in the creation, accessing, updating, and transfer of patient medical records contained in databases 20a, 20b, 20k. To that end, computers 18a, 18b, . . . 18k are each loaded with at least one applications program which modifies the generic digital data processing circuits of the respective computer to produce functional computer modules which create, modify, and transfer patient medical records.

The distributed medical data processing and communication system of FIG. 1 further comprises a plurality of prescription fulfillment computers 22a, 22b, . . . 22m, a plurality of insurer computers 24a, 24b, . . . 24n, a prescription interaction database 26, and a prescription indication database 28 all operatively coupled to network 16. Server computers (not shown) may be provided for regulating access to prescription interaction database 26 and prescription indication database 28.

Prescription fulfillment computers 22a, 22b, . . . 22m are each loaded with at least one applications program which handles incoming orders for prescription drugs. The application program checks incoming prescriptions for content, prescriber authority, billing party, etc.

Insurer computers 24a, 24b, . . . 24n are used by insurance companies to monitor and process drug prescriptions, as well as other medical expenses. Insurer computers 24a, 24b, . . . 24n are accordingly provided with applications software suitable for insurance activities.

The various applications programs on computers 12a, 12b, . . . 12i, 18a, 18b, 18k, 22a, 22b, . . . 22m, and 24a, 24b, . . . 24n, as well as the applications software on handlheld wireless prescription generators 14a, 14b, . . . 14j, are typically written in different programming languages characterized by different formatting conventions. Even if the same language is used to produce two applications programs, the formatting conventions may be different, so that the same data is located in different places and organized differently.

As further illustrated in FIG. 1, a server computer 30 acting as a prescription monitor and code translator is operatively connected to all of the computers of FIG. 1 via the computer network 16. The code translator programming of server computer 30 receives electronic prescriptions from computers 12a, 12b, . . . 12i and hand-held prescription generators 14a, 14b, . . . 14j and converts the formatting of those electronic prescriptions into a predefined common or universal format. The prescription monitor programming of server computer 30 then checks the prescription for possible undesirable drug interactions. To that end, server computer 30 is operatively connected to prescription interaction database 26 and prescription indication database 28 either directly or indirectly via computer network 16.

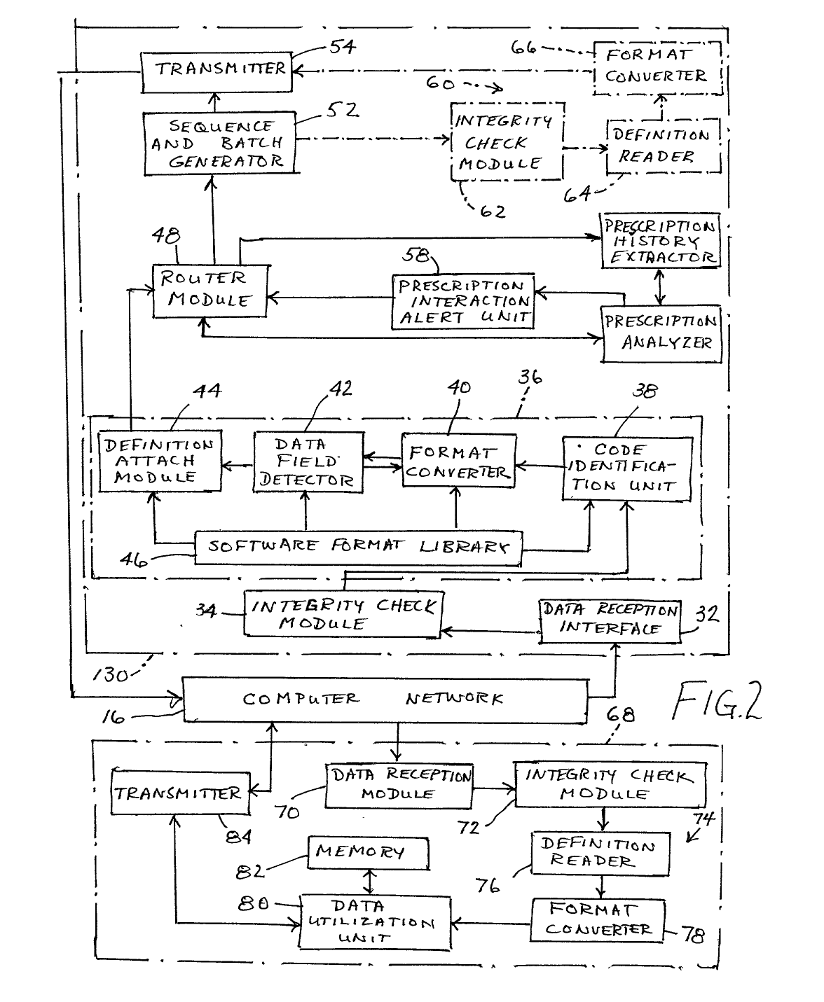

As shown in FIG. 2, server computer 30 includes an interface 32 connected to computer network 16 for receiving, extracting or retrieving blocks of data from the different applications programs of computers 12a, 12b, . . . 12i, 18a, 18b, . . . 18k, 22a, 22b, . . . 22m, and 24a, 24b, . . . 24n, as well as the applications software on handlheld wireless prescription generators 14a, 14b, . . . 14j. The blocks of data encoded in accordance with respective formatting conventions. For instance, the applications software of the various prescription generating computers 12a, 12b, . . . 12i may be written in different languages or may simply organize the same information in different ways.

Interface 32 is connected on a downstream side to an integrity check module 34 which examines incoming data blocks to determine whether the blocks have been degraded or otherwise altered in transmission. If so, module 34 may generate a request for a retransmission of the respective data bock. Integrity check module 34 is in turn connected at an output to a code translator 36 which includes a code identification or recognition unit 38 for determining, for each incoming data block, the formatting convention of the incoming data block. This procedure includes identification of the programming language in which the data block is written.

Code identification or recognition unit 38 is operatively linked to a format converter 40 which cooperates therewith to convert incoming data blocks from respective formatting conventions to a predetermined common formatting convention. Code translator 36 further includes a data field detector 42 operatively coupled to format converter 40 for identifying types of data elements in the incoming data blocks and a definition attach module 44 operatively connected to the data field detector for associating data definitions with respective data elements. Integrity check module 36, code identification or recognition unit 38, format converter 40, data field detector 42, and definition attach module 44 are operatively linked to a format library 46 which stores different formatting conventions of all known applications programs.

Code translator 36 is operatively connected at an output to a router module 48 which determines the destinations of incoming data blocks. Where an incoming data block pertains to a new electronic prescription, router module 48 directs the converted data to a prescription analyzer 50. In response to patient identification information contained in a new prescription, analyzer 50 generates a request for the respective patient's medical history. This request is forwarded by router module 48 over a sequence and batch generator 52 and a transmitter 54 to one or more record keeping computers 18a, 18b, . . . 18k (FIG. 1). The contacted computers 18a, 18b, . . . 18k access their respective records keeping databases 20a, 20b, . . . 20k and transmit the requested patient records back over computer network 16 to interface 32 of server computer 30. Router module 48 directs incoming patient medical records to a prescription history extraction module 56.

Analyzer 50 is connected at an input to prescription history extraction module 56 for determining whether a patient identified in a new electronic prescription is currently taking any other prescription medication. Upon determining that a patient is indeed on other medications, analyzer 50 generates a request for drug interaction information pertaining at least in part to combinations of the newly prescribed drug or pharmaceutical agent with the other medications currently being taken by the subject patient. The drug interaction information preferably also includes possible allergic reactions of the patient to the newly prescribed drug, possible organic or physiological reactions of the patient due to pre-existing medical conditions, possible drug-food interactions, etc. Again, this request is forwarded by router module 48 over sequence and batch generator 52 and transmitter 54 to prescription interaction database 26 (FIG. 1). The requested drug interaction information is transmitted from database 26 over computer network 16 to interface 32 of server computer 30. It is to be noted that the formatting convention of the drug interaction data stored in database 26 is converted by code translator 36 into the common data format for utilization by analyzer 50.

Router module 48 directs incoming drug interaction information to analyzer 50. Upon receiving the drug interaction information, analyzer 50 advises an alert signal generator 58 if there is a potentially hazardous drug interaction (drug-drug, drug-food, drug-physiology, drug-allergy, etc.). Signal generator 58 is operatively tied to router module 48 which relays the alert signal with the respective electronic prescription to a destination, such as a prescription fulfillment computer 22a, 22b, . . . 22m. Alternatively, or additionally, and perhaps depending on the seriousness of the potential drug interaction, router module 48 might inform the originating computer 12a, 12b, . . . 12i.

As further illustrated in FIG. 2, server computer 30 may include a second code translator 60 operatively connected to code translator 36 via router module 48 for transforming each data block from the common formatting convention into a formatting convention for use by a destination applications program. The destination applications program or computer is generally identified in the original electronic prescription. Code translator 60 may include an integrity check module 62, a definition reader 64, and a format converter 66. These elements, particularly definition reader 64 and format converter 66 are connected to format library 46.

In an alternative system configuration, the data blocks relayed by server computer 30 from a first applications program on one computer 12a, 12b, . . . 12i, 18a, 18b, . . . 18k, 22a, 22b, . . . 22m, and 24a, 24b, . . . 24n (or prescription generator 14a, 14b, . . . 14j), to a second applications program on another computer 12a, 12b, . . . 12i, 18a, 18b, . . . 18k, 22a, 22b, . . . 22m, and 24a, 24b, . . . 24n, are transmitted from server computer 30 over network 16 in the predetermined common or universal format. Transformation of the data blocks from the common format to respective formatting conventions of the different applications programs is then accomplished at the respective destination computers 12a, 12b, . . . 12i, 18a, 18b, . . . 18k, 22a, 22b, . . . 22m, and 24a, 24b, . . . 24n. To that end, a representative destination computer 68 includes a data reception module or interface 70, an integrity check module 72 and a code translator 74 including a definition reader 76 and a format converter 78. Code translator 74 is operatively connected to a data processing or data utilization unit 80 which comprises a plurality of generic digital processing circuits modified by an applications program such as an accounting program, a patient or medical record keeping program, an insurance administration program, a prescription generating program, or a prescription fulfillment program. Data processing or data utilization unit 80 is operatively connected to a memory 82 which contains the respective applications program, as well as other programs and data, and to a transmitter 84 by which the destination computer 68 communicates with server computer 30 and other computers 12a, 12b, . . . 12i, 18a, 18b, . . . 18k, 22a, 22b, . . . 22m, and 24a, 24b, . . . 24n via network 16.

Server computer 30, and particularly interface 32 thereof, receives electronic prescriptions from prescription generating applications programs on computers 12a, 12b, . . . 12i and from hand-held wireless prescription generators 14a, 14b, . . . 14j via computer network 16. Code translator 36 converts the formats of incoming data blocks of the electronic prescriptions from the original formats inherent in the prescription generating applications programs to a common formatting convention. Server computer 30 and particularly router module 48 and prescription analyzer 50 thereof operate to automatically analyze the converted electronic prescriptions to detect possible dangers to respective patients for whom the electronic prescriptions are generated. Where security measures have been implemented for protecting patient privacy, the proper authorization and identification codes are obtained by computer 30 from prescription generating computers 12a, 12b, . . . 12i and from hand-held wireless prescription generators 14a, 14b, . . . 14j via computer network 16. These authorization and identification codes enable at least a selective access to patient medical records stored on databases 20a, 20b, . . . 20k of computers 18a, 18b, . . . 18k.

After determining whether there is any possible drug interaction (including drug-drug reactions, drug-food reactions, drug-medical condition reactions, allergies, etc.) for a particular patient for whom a new electronic prescription has been received, server computer 30 and particularly router 48, sequence and batch generator 52 and transmitter 54 (and optionally code translator 60) transmit the analyzed electronic prescriptions to respective target applications programs via computer network 16. The analyzed electronic prescriptions and results of the prescription analysis generated by prescription analyzer 50 and router module 48 may be automatically converted or transformed into preselected software formats by code translators 74 located on the respective destination computers 68. Alternatively, the analyzed electronic prescriptions and results of the prescription analysis may be automatically converted or transformed into preselected software formats by code translator 60 located on server computer 30.

With respect to a data handling and transfer function of server computer 30, incoming data blocks received by interface 32 from different applications programs on computers 12a, 12b, . . . 12i, 18a, 18b, . . . 18k, 22a, 22b, . . . 22m, and 24a, 24b, . . . 24n, as well as from the applications software on handlheld wireless prescription generators 14a, 14b, . . . 14j, are automatically converted from the respective data formatting conventions to a predetermined common data formatting convention by code translator 36. Types of data elements are identified by data field detector 42, while data definitions are attached to respective data elements by definition attach module 44. Subsequently, each converted data block is automatically converted or transformed from the common formatting convention into a respective target formatting convention by central code translator 60 or distributed code translators 74 for use by a respective one of the applications programs.

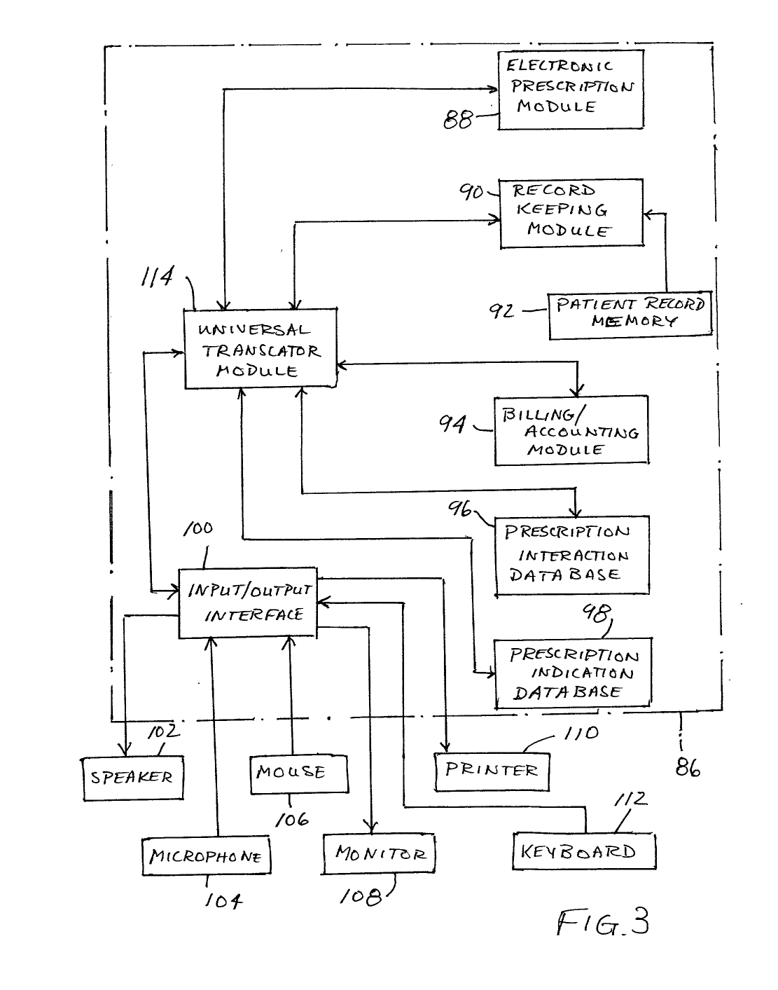

As illustrated in FIG. 3, the various applications programs which are relevant in creating, processing, handling, storing, and checking electronic medical prescriptions may be located on a single computer 86. Each applications program modifies generic digital data processing circuits of computer 86 to create a respective functional module. These modules include, but are not limited to, an electronic prescription generating module 88, a record keeping module 90 connected to a patient or medical record database 92, and a billing and accounting module 94. Computer 86 includes or is connected to a drug interaction database 96 and a prescription indication database 98. Computer 86 further includes an input/output interface 100 which is connected to various peripherals including a speaker 102, a microphone 104, a mouse 106, a monitor 108 (e.g., with touchscreen), a printer 110, and a keyboard 112. Where databases 96 and 98 are separate from computer 86, and possibly located remotely, input/output interface 100 may be connected to those databases via dedicated lines or via a wired or wireless computer network (not shown in FIG. 3).

Computer 86 also includes a universal translator module 114 which performs prescription monitoring and code translation functions as described hereinabove with reference to server computer 30. Translator module 114 is connected to electronic prescription generating module 88, record keeping module 90, billing and accounting module 94, drug interaction database 96, and prescription indication database 98. Translator module 114 is also connected to speaker 102, microphone 104, mouse 106, monitor 108, printer 110, and keyboard 112 via input/output interface 100.

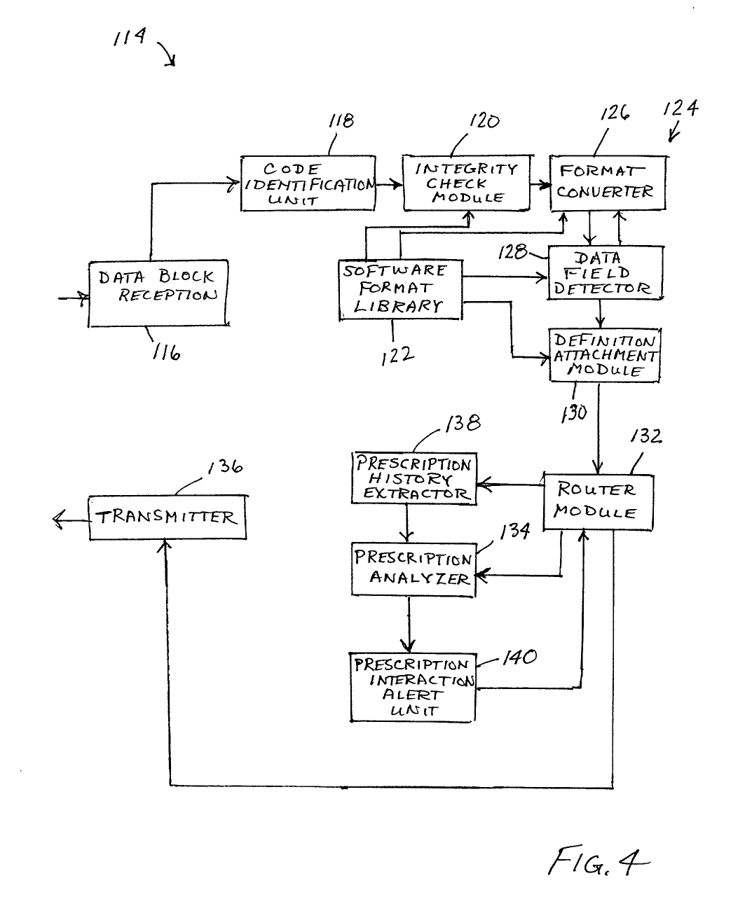

As illustrated in FIG. 4, translator module 114 includes a data-block reception interface 116 connected on a downstream side to a code identification or recognition unit 118 and an integrity check module 120. Integrity check module 120 performs an integrity evaluation of data blocks arriving from prescription generating module 88, record keeping module 90, billing and accounting module 94, drug interaction database 96, and prescription indication database 98. Code identification or recognition unit 118 determines, in conjunction with a software format library 122, the formatting convention of each incoming data block.

Translator module 114 further includes a code translator 124 which in turn includes a format converter 126, a data field detector 128, and a definition attach module 130 all connected to library 122. Format converter 126 cooperates with library 122 and code identification or recognition unit to convert incoming data blocks from respective formatting conventions to a predetermined common formatting convention. Data field detector 128 identifies types of data elements in the incoming data blocks and definition attach module 44 associates data definitions with respective data elements of the data blocks. Format library 122 stores different formatting conventions of the applications programs underlying electronic prescription generating module 88, record keeping module 90, billing and accounting module 94, drug interaction database 96, and prescription indication database 98.

Code translator 124 is operatively connected at an output to a router module 132 which determines the destinations of incoming data blocks, i.e., the program modules 88, 90, and 94, the databases 96 and 98, and the peripherals 102, 104, 106, 108, 110, and 112 to which communications are directed. Where an incoming data block pertains to a new electronic prescription, router module 132 directs the converted data to a prescription analyzer 134. In response to patient identification information contained in a new prescription, analyzer 134 generates a request for the respective patient's medical history. This request is forwarded by router module 132 over a transmitter 136 to records keeping module 90 (FIG. 3), which accesses database or memory 92 and relays the requested patient records back to interface 116 of translator module 114. Router module 132 directs incoming patient medical records to a prescription history extraction module 138.

Analyzer 134 is connected at an input to prescription history extraction module 138 for determining whether a patient identified in a new electronic prescription is currently taking any other prescription medication. Upon determining that a patient is indeed on other medications, analyzer 134 generates a request for drug interaction information pertaining to combinations of the newly prescribed drug or pharmaceutical agent with the other medications currently being taken by the subject patient, as well as pertaining to possible allergic reactions of the patient to the newly prescribed drug, possible organic or physiological reactions of the patient due to pre-existing medical conditions, possible drug-food interactions, etc. This request is forwarded by router module 132 to drug interaction database 96. The requested drug interaction information is transmitted from database 96 to interface 116 of translator module 114. If necessary, the formatting convention of the drug interaction data stored in database 96 is converted by code translator 124 into the common data format for utilization by analyzer 134.

Router module 132 directs incoming drug interaction information to analyzer 134. Upon receiving the drug interaction information, analyzer 134 advises a prescription interaction alert unit 140 if there is a potentially hazardous drug interaction. Prescription interaction alert unit 140 is operatively tied to router module 132 which relays an alarm signal with the respective electronic prescription to a computer operator via, for instance, input/output interface 100 and speaker 102, monitor 108, or printer 110.

Prescription analyzer 134 may similarly utilize data from prescription indication database 98 and patient record memory 92 to perform an automatic check on the suitability of a prescription, given the recorded symptoms, condition and medical history of the patient. In the event of an inconsistency of a newly generated prescription with treatment schedules provided in database 98, prescription analyzer 134 may induce the generation of an alert signal by alert unit 140.

Each participant computer in a network may have a translator module including a code translator for transforming each incoming data block from the common formatting convention into a formatting convention for use by a destination applications program on the respective participant computer. The destination program is generally identified by an originating applications program, for instance, an electronic prescription generating program. The code translator may include an integrity check module, a definition reader, and a format converter. These elements, particularly the definition reader and the format converter are connected to a format library provided on the individual participating computer or on a server computer in the respective network, where that network is a local area network, a private regional or global computer network (e.g., corporate), a public global computer network, namely, the Internet, or a closed password-protected portion of the Internet known as an Intranet, or a combination of these networks.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An electronic medical prescription handling system comprising:
an interface for receiving or retrieving blocks of data from different applications programs including electronic prescription generating software, said blocks of data being encoded in accordance with respective formatting conventions;
a code translator operatively tied to said interface for converting each incoming data block from a respective formatting convention to a predetermined common formatting convention;
a prescription analyzer operatively connected to said code translator for checking an incoming medical prescription for potential drug interaction; and
an alert signal generator operatively coupled to said prescription analyzer for generating an alert signal upon detection of a drug interaction possibly resulting in a person by filling and use of the medical prescription.

2. The system defined in claim 1 wherein said code translator is a first code translator, further comprising a second code translator operatively connected to said first code translator for converting data blocks from said common formatting convention to another formatting convention for use by one of said applications programs.

3. The system defined in claim 2, further comprising a data transmitter operatively coupled to said second code translator for transmitting converted data blocks therefrom to a remote computer containing said one of said applications programs.

4. The system defined in claim 3, further comprising a batch and sequence generator operatively connected at an input side to said second code translator and at an output side to said data transmitter.

5. The system defined in claim 2 wherein said second code translator is operatively connected to said prescription analyzer for incorporating prescription analysis into transmissions to said one of said applications programs.

6. The system defined in claim 2 wherein said second code translator is operatively connected to said prescription analyzer for incorporating said alert signal into a transmission to said one of said applications programs.

7. The system defined in claim 1 wherein said code translator includes a code identification or recognition unit operatively linked to said interface for determining, for each incoming data block, the formatting convention of the incoming data block.

8. The system defined in claim 1 wherein said code translator includes:
a data field detector for identifying types of data elements in the incoming data blocks; and
a definition attach module operatively connected to said data field detector for associating data definitions with respective data elements.

9. The system defined in claim 1 wherein said interface is connected to a computer network, said code translator and said prescription analyzer being located on a first computer connected to said network, at least one of said applications programs being located on a different second computer connected to said network.

10. The system defined in claim 1 wherein said applications programs are taken from the group consisting of accounting programs, patient record keeping programs, medical record keeping programs, insurer programs, prescription generating programs, prescription fulfillment programs, claims processing programs, drug formulary programs, and drug interaction systems.

11. The system defined in claim 1 wherein said prescription analyzer includes means for accessing a record keeping database.

12. The system defined in claim 1 wherein said prescription analyzer includes means for accessing a prescription interaction database.

13. The system defined in claim 1, further comprising an integrity check module operatively linked to said interface and said code translator for verifying integrity of incoming data blocks.

14. A data handling and transfer system comprising:
an interface for receiving or retrieving blocks of data from different applications programs including electronic prescription generating software, said blocks of data being encoded in accordance with respective formatting conventions;
a first code translator operatively tied to said interface for converting each incoming data block from the respective formatting convention to a predetermined common formatting convention, said first code translator including (a) a data field detector for identifying types of data elements in the incoming data blocks and (b) a definition attach module operatively connected to said data field detector for associating data definitions with respective data elements; and
a second code translator operatively connected to said first code translator for converting each data block from said common formatting convention into a target software formatting convention for use by one of said applications programs.

15. The system defined in claim 14 wherein said interface is connected to a computer network, said first code translator being located on a first computer connected to said network, said one of said applications programs being located on a second computer connected to said network.

16. The system defined in claim 15 wherein said second code translator is located on said first computer.

17. The system defined in claim 15 wherein said second code translator is located on said second computer.

18. The system defined in claim 14, further comprising a data transmitter operatively coupled to said second code translator for transmitting converted data blocks therefrom to a remote computer containing said one of said applications programs.

19. The system defined in claim 18, further comprising a batch and sequence generator operatively connected at an input side to said second code translator and at an output side to said data transmitter.

20. The system defined in claim 14, further comprising data processing module connected between said first code translator and said second code translator for operating on data blocks in said common formatting convention.

21. The system defined in claim 20 wherein said data processing module includes a prescription analyzer operatively connected to said first code translator and to at least one medical database for checking an incoming medical prescription for potential drug interaction.

22. The system defined in claim 14 wherein said first code translator includes a code identification or recognition unit operatively linked to said interface for determining, for each incoming data block, the software formatting convention of the incoming data block.

23. The system defined in claim 14, further comprising an integrity check module operatively linked to said interface and said first code translator for verifying integrity of incoming data blocks.

24. The system defined in claim 14 wherein said applications programs are taken from the group consisting of accounting programs, patient record keeping programs, medical record keeping programs, insurer programs, prescription generating programs, prescription fulfillment programs, claims processing programs, drug formulary programs, and drug interaction systems.

25. A medical risk control method comprising:
receiving electronic prescriptions encoded in accordance with a variety of different software formatting conventions;
automatically converting the received electronic prescriptions from the respective formats into a common formatting convention;
operating a computer to automatically analyze the converted electronic prescriptions to detect possible dangers to respective patients for whom the electronic prescriptions are generated; and
transmitting the analyzed electronic prescriptions to respective target applications programs.

26. The method defined in claim 25, further comprising automatically converting the analyzed electronic prescriptions and results of the prescription analysis into preselected software formats utilizable by the respective target applications programs.

27. The method defined in claim 26 wherein the converting of the analyzed electronic prescriptions and the results of the prescription analysis is performed prior to the transmitting of analzyed electronic prescriptions to the respective target applications programs.

28. The method defined in claim 26 wherein the converting of the analyzed electronic prescriptions and the results of the prescription analysis is performed after the transmitting of analzyed electronic prescriptions to the respective target applications programs, the converting of the analyzed electronic prescriptions and the results of the prescription analysis being performed at a location remote from said computer.

29. The method defined in claim 25 wherein the electronic prescriptions are received over a computer network from remote computers, the target applications programs being located on remote computers, the transmitting of the analyzed electronic prescriptions including transmitting the analyzed electronic prescriptions over said computer network.

30. The method defined in claim 25 wherein the automatic converting of the received electronic prescriptions from the respective formats into a common formatting convention includes identifying types of data elements in the received electronic prescriptions and attaching data definitions to respective data elements.

31. The method defined in claim 25 wherein the electronic prescriptions are generated for respective patients and wherein the operating of said computer to automatically analyze the received electronic prescriptions includes:
accessing a medical records database to determine drugs currently being taken by the respective patients;
automatically accessing a drug interaction database; and
automatically determining whether fulfillment and utilization of any one of the electronic prescriptions by a respective one of the patients is contraindicated by a possible deleterious drug interaction.

32. The method defined in claim 25 wherein the automatic converting of the received electronic prescriptions from the respective formats into a common formatting convention includes automatically determining, for each incoming data block, the formatting convention of the incoming data block.

33. The method defined in claim 25 wherein said applications programs are taken from the group consisting of accounting programs, patient record keeping programs, medical record keeping programs, insurer programs, prescription generating programs, prescription fulfillment programs, claims processing programs, drug formulary programs, and drug interaction systems.

34. The method defined in claim 25, further comprising automatically verifying integrity of incoming data blocks.

35. A data handling and transfer method comprising:
receiving incoming data blocks from different applications programs including electronic prescription generating software, said incoming data blocks being encoded in accordance with respective formatting conventions;
automatically converting each incoming data block from the respective formatting convention to a predetermined common formatting convention, the converting of each data block including (a) identifying types of data elements in the respective data block and (b) attaching data definitions to respective data elements; and
automatically transforming each converted data block from said common formatting convention into a target software formatting convention for use by at least one of said applications programs.

36. The method defined in claim 35 wherein the converting and the transforming of the data blocks occur on the same computer.

37. The method defined in claim 36, further comprising transmitting transformed data blocks to a remote computer containing said one of said applications programs.

38. The method defined in claim 35 wherein the converting and the transforming of the data blocks occur on different computers connected to one another via a network, further comprising transmitting the converted data blocks from a first one of the different computers to a second one of the different computers prior to the transforming of the converted data blocks.

39. The method defined in claim 35 wherein said incoming data blocks are received over a computer network from remote computers, the converting and transforming of data blocks being performed on one computer, said one of said applications programs being located on a different computer connected to said network.

40. The method defined in claim 35, further comprising transmitting transformed data blocks to a remote computer containing said one of said applications programs.

41. The method defined in claim 35, further comprising operating on converted data blocks in said common formatting convention prior to transforming of the data blocks.

42. The method defined in claim 38 wherein said data blocks include electronic medical prescriptions and wherein the operating on converted data blocks includes accessing at least one medical database and checking an incoming medical prescription for potential drug interaction.

43. The method defined in claim 35 wherein said applications programs are taken from the group consisting of accounting programs, patient record keeping programs, medical record keeping programs, insurer programs, prescription generating programs, prescription fulfillment programs, claims processing programs, drug formulary programs, and drug interaction systems.
